(19) United States
(12) Patent Application Publication
(10) Pub. No.: US 2025/0156918 A1
(43) Pub. Date: May 15, 2025

(54) APPARATUS FOR SECURE AND AUTHORIZED CREATION OF PERSONALIZED MERCHANDISE ITEMS WITH SELECTED IMAGES

(71) Applicant: Yearbooker, Inc., Vernon, NJ (US)

(72) Inventors: Robert Davidson, Vernon, NJ (US); Fanny Chung Davidson, Vernon, NJ (US)

(73) Assignee: Yearbooker, Inc., Vernon, NJ (US)

(21) Appl. No.: 19/023,230

(22) Filed: Jan. 15, 2025

Related U.S. Application Data
(63) Continuation of application No. 17/728,028, filed on Apr. 25, 2022, now Pat. No. 12,217,293.
Application No. 17/728,028 is a continuation-in-part of application No. 16/724,615, filed on Dec. 23, 2019, now abandoned.
Application No. 16/724,615 is a division of application No. 16/256,693, filed on Jan. 24, 2019, now Pat. No. 10,552,886.
Application No. 16/256,693 is a continuation of application No. 16/102,219, filed on Aug. 13, 2018, now abandoned.
Application No. 16/102,219 is a continuation of application No. 15/484,954, filed on Apr. 11, 2017, now Pat. No. 10,713,219.
(60) Provisional application No. 62/544,785, filed on Aug. 12, 2017.
(60) Provisional application No. 62/320,663, filed on Apr. 11, 2016.

(51) Int. Cl. G06Q 30/0601; G06F 3/0482; G06F 3/0486; G06F 3/0488; H04L 67/10

(52) U.S. Cl. CPC G06Q 30/0621; G06F 3/0482; G06F 3/0486; G06F 3/0488; H04L 67/10

(57) ABSTRACT

Apparatus for generating merchandise items with selected images including a communication interface to receive user requests, a processor to determine user permissions, and an authorization system to verify permissions from necessary parties. The apparatus ensures that merchandise is created only if all required permissions are obtained. It features a merchandise creation system to produce the item with the selected image, a user interface to display permission status, and a notification system to inform users upon completion. The apparatus supports multiple merchandise formats and communication protocols, handles simultaneous requests, and ensures secure data handling. It also includes a database for storing permission data and logs authorization activities, providing a comprehensive solution for personalized merchandise creation.

### CROSS-REFERENCE TO RELATED APPLICATIONS

The present application is a continuation of and claims priority to U.S. Nonprovisional application Ser. No. 17/728,028, filed Apr. 25, 2022, and entitled METHODS AND APPARATUS FOR MERCHANDISE GENERATION INCLUDING AN IMAGE; which is a continuation-in-part of and claims priority to U.S. Nonprovisional application Ser. No. 16/724,615, filed Dec. 23, 2019, and entitled METHODS AND APPARATUS FOR MERCHANDISE GENERATION INCLUDING AN IMAGE; which is a divisional of and claims priority to U.S. Nonprovisional application Ser. No. 16/256,693, filed Jan. 24, 2019, and entitled METHODS AND APPARATUS FOR MERCHANDISE GENERATION INCLUDING AN IMAGE; which is a continuation of and claims priority to U.S. Nonprovisional application Ser. No. 16/102,219, filed Aug. 13, 2018, and entitled METHODS AND APPARATUS FOR DYNAMIC, EXPRESSIVE ANIMATION BASED UPON SPECIFIC ENVIRONMENTS; which claims the benefit of U.S. Provisional Application No. 62/544,785, filed Aug. 12, 2017, and entitled METHODS AND APPARATUS FOR DYNAMIC, EXPRESSIVE ANIMATION BASED UPON SPECIFIC ENVIRONMENTS; and U.S. Nonprovisional application Ser. No. 16/102,219 is a continuation of U.S. Nonprovisional application Ser. No. 15/484,954, filed Apr. 11, 2017, and entitled METHODS AND APPARATUS FOR DYNAMIC IMAGE ENTRIES; which claims the benefit of U.S. Provisional Patent Application No. 62/320,663, filed Apr. 11, 2016, and entitled METHODS AND APPARATUS FOR INTERACTIVE MEMORY BOOK WITH MOTION BASED ANNOTATIONS; the contents of each of which are relied upon in their entirety and incorporated herein by reference. This application cross-references and incorporates by reference the disclosure found in application Ser. No. 15/099,841.

### FIELD OF THE DISCLOSURE

The present disclosure relates to methods and an apparatus for quickly and easily creating customized merchandise items, such as t-shirts, photo reprints, photo books, mugs, and calendars, based on static images.

### BACKGROUND OF THE DISCLOSURE

Websites allowing a user to generate merchandise, such as t-shirts, mugs, and calendars, from certain images have existed for many years. However, their use is inconvenient. The user must either select an image from a pre-populated list of images the website owner has the rights to use, or upload his own.

The user seeking to create merchandise based off his own image must go through several time-consuming steps, such as locating the desired image, ensuring he has the rights to create merchandise based off the image, editing the image to meet his needs, finding a website that creates the specific type of merchandise he wants, and uploading the image to the website.

User uploads pose a potential legal problem for the website owner as well. For example, if the user chooses the Coca-Cola® logo as his image and begins selling Coca-Cola® t-shirts from the website, then the website could be liable for contributory trademark infringement. Additionally, if the user uploads a picture of someone else's child, that child's parents may be able to sue the website owner for misappropriating their child's likeness.

### SUMMARY OF THE DISCLOSURE

Accordingly, the present invention provides apparatus and methods for generating a physical article of merchandise in the physical world and virtual article of merchandise in a virtual world, the apparatus including a computer server for post processing the digital image data, the computer server in logical communication with an image capture device and accessible with a network access device via a digital communications network.

Embodiments may also include executable software stored on the computer server and executable on demand, the software operative with the servers to cause the apparatus to receive digital image data from the image capture device, the digital image data representative of one or more digital photos, such as a first photo and a second photo. A user may provide an input to the server choosing a desired article of merchandise, and the first digital photo to be applied to the article of merchandise. Embodiments may also include associate Cartesian Coordinates with specified segregated spatial areas of the first digital photo received from the image capture device and designating an area to apply the first digital photo to the article of merchandise.

Embodiments may also include receiving a second digital photo and prompting the first user to designate desired Cartesian Coordinates on the article of merchandise. In some embodiments, to apply the first digital photo and the second digital photo. Embodiments may also include manufacture the article of merchandise in the physical world (“physical merchandise”), the physical merchandise including a replication of the first digital photo and the second digital photo.

Embodiments may also include generate a virtual article of merchandise in the virtual world (“virtual merchandise”), the virtual merchandise including a virtual replication of the first digital photo and the second digital photo. Embodiments may also include generate a non-fungible token (“NFT”) for the virtual merchandise. Embodiments may also include transferring the physical merchandise to the first user. Embodiments may also include transfer ownership of the NFT to the first user.

In some embodiments, an image stored remotely or on a user's device is referenced to generate merchandise, such as a t-shirt, mug, photo reprint, photo book, Yearbooker, a hat and a calendar, and to place a chosen image content in a position upon a merchandise item via simple drag and drop of an image across a user interface to a selected Merchandise Item. In some embodiments, a user identification will additionally authenticate the user's rights to generate merchandise including a selected image.

A system of one or more computers can be configured to perform particular operations or actions by virtue of having software, firmware, hardware, or a combination of them installed on the system that in operation causes the system to perform specific actions, such as receive sensor input, execute method steps based upon the sensor input. One or more computer programs can be configured to perform particular operations or actions by virtue of including instructions that, when executed by data processing apparatus, cause the apparatus to perform the actions.

### BRIEF DESCRIPTION OF THE DRAWINGS

The accompanying drawings are incorporated in and constitute a part of this specification, illustrate several embodiments of the disclosure, and together with the description, serve to explain the principles of the disclosure:

FIGS. 1A-1B illustrate examples of user interfaces that may be used in some embodiments of the present invention.

FIGS. 2A-2B illustrate examples of additional user interfaces that may be used in some embodiments of the present invention.

FIGS. 3A-3B illustrate examples of additional user interfaces that may be used in some embodiments of the present invention.

FIG. 4 illustrates a block diagram of apparatus and user interface that may be generated by the apparatus according to some embodiments of the present invention.

FIG. 5 illustrates an exemplary embodiment of a method for authenticating the rights of the user requesting Merchandise.

FIG. 6 illustrates an exemplary embodiment of an apparatus that may be used to implement some aspects of the present disclosure including executable software.

FIG. 7 illustrates a schematic diagram of aspects of the present invention.

FIG. 8 illustrates a flow chart with method steps that may be executed according to some variants of the present invention.

### DETAILED DESCRIPTION

The present disclosure provides generally for an apparatus and method for ordering image-based articles of physical Merchandise in a physical world and corresponding virtual articles of merchandise associated with NFTs.

In the following sections, detailed descriptions of examples and methods of the disclosure will be given. the description of both preferred and alternative examples though through are exemplary only, and it is understood that to those skilled in the art that variations, modifications, and alterations may be apparent. It is therefore to be understood that the examples do not limit the broadness of the aspects of the underlying disclosure as defined by the claims.

### Glossary

“Blockchain” as used herein refers to a shared, immutable ledger that is capable of recording transactions and/or tracking assets in a distributed network. An asset can may be a physical world, tangible article, or intangible item, including an item in a virtual world and/or an NFT.

“Device,” as used herein, refers to any smart device (comprising a controller and a storage) or computer, having a processor, memory, and network access device. Device includes, but is not limited to, smart phones, cellular phones, desktop computers, laptop computers, and tablet computers.

“Non-Fungible Token” (“NFT”) to some embodiments, of the present invention an NFT is a one-of-a-kind digital token created (or “minted”) and recorded on a digital ledger, called a blockchain. NFTs can be bought and sold like any other property, but they have no physical form. NFTs are “non-fungible” (i.e., unique, and not interchangeable) because each token comprises unique data (e.g., code and other metadata) that distinguishes it from other NFTs relating to the relevant blockchain. Blockchain solutions like the public Ethereum network, Polkadot, Cosmos and Flow can be used to create NFTs. The NFTs can then be bought and sold via an NFT marketplace website that is linked to the underlying blockchain solution (e.g., OpenSea). According to the present invention the buying and selling of a NFT 367 may be tied to the sale of a corresponding physical item 310. Furthermore, in some embodiments, the NFT may exist in a virtual world, such as a metaverse.

“Merchandise,” as used herein, refers to one or more of any number of potentially desirable items that a user may want to generate from an image. Merchandise includes, but is not limited to, hats, t-shirts, coffee mugs, calendars, photo books, and wall art.

“Public Ledger” as used herein refers to as a record-keeping system that maintains participants' identities in secure and (pseudo-)anonymous form, their respective NFT assets, and a record book of all the genuine transactions executed between network participants.

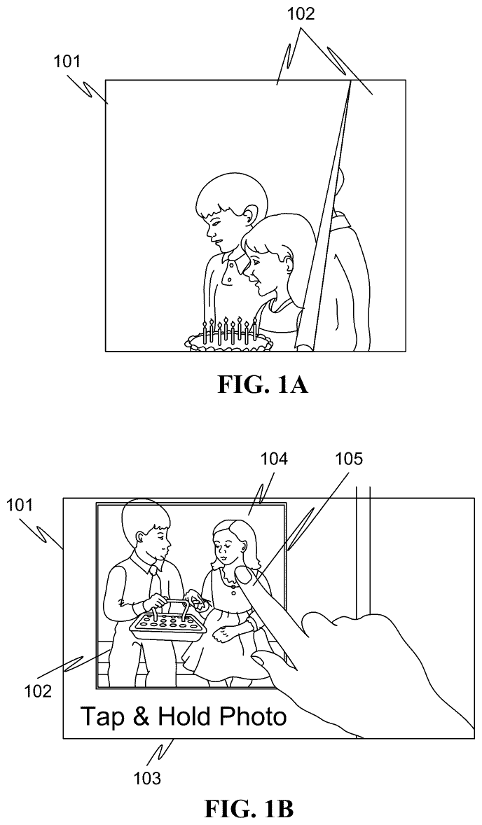

Referring now to FIG. 1A, an image display application 101 appears on the user's Device. The image display application 101 allows a user to view one or more images 102. In some embodiments, the one or more images will include a memory or photo book memorializing an event. Events may include a life event, such as a birthday, anniversary, wedding, christening, photo session, bar mitzvah or bat mitzvah. Other embodiments include a collection of images included in a school yearbook. This disclosure incorporates by reference U.S. Pat. No. 9,030,496 for disclosure describing a source of image data.

Referring now to FIG. 1B, when an image 102 appears on the image display application 101, the image display application 101 may cause instructions 103 for selecting a particular image to appear on the Device's display. In a preferred embodiment, this instruction 103 comprises the phrase “Tap & Hold photo.” In this preferred embodiment, the Device also comprises a capacitive screen 104 that displays the image 102 may be responsive to a user action, such as a user providing a source of body heat (i.e., the user's finger) 105, thus allowing the user to carry out instruction 103 to select the particular image. In an alternative embodiment, the instructions 103 prompt the user to use a computer mouse to click the particular image 102. The image 102 may be associated with spatial coordinates, such as Cartesian Coordinates or Polar Coordinates.

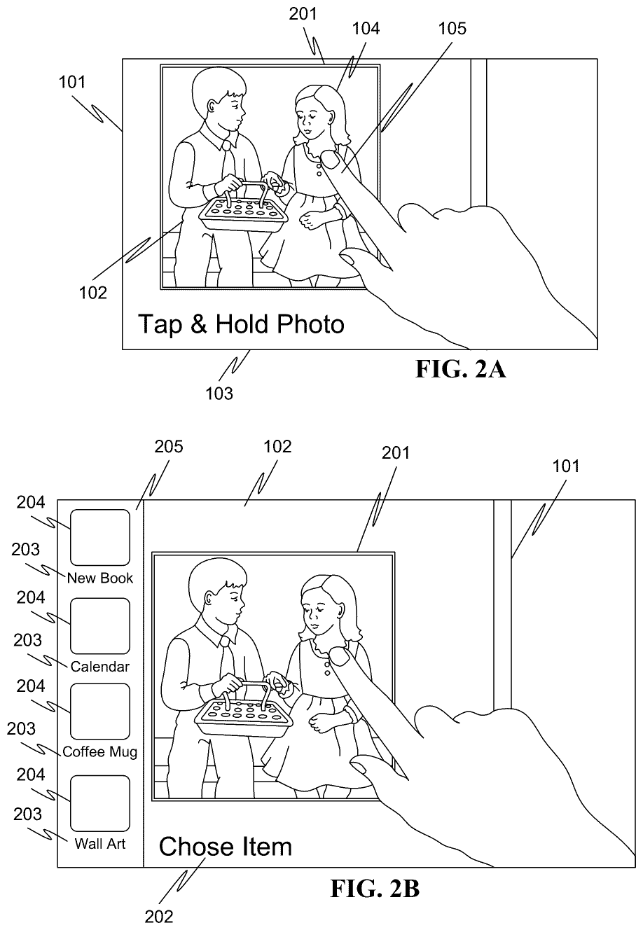

Referring now to FIG. 2A, once the user indicates a selection of an image 102 by following instruction 103, the image display application 101 applies a visual indication of selection 201 to the selected image 102 or a portion of selected image 102 by, for example, at least one of: surrounding the image 102 or portion of image 102 with a colored border; causing the image 102 or portion of image 102 to wiggle; causing image 102 or portion of image 102 to be highlighted or glow; and the like.

Referring now to FIG. 2B, once the image 102 is selected 201, the image display application 101 opens a side menu 205. Side menu 205 comprises one or more Merchandise options 203, and off-shade, picture frame-shaped boxes 204. The image display application 101 displays instructions 202 to instruct the user on how to choose the desired Merchandise.

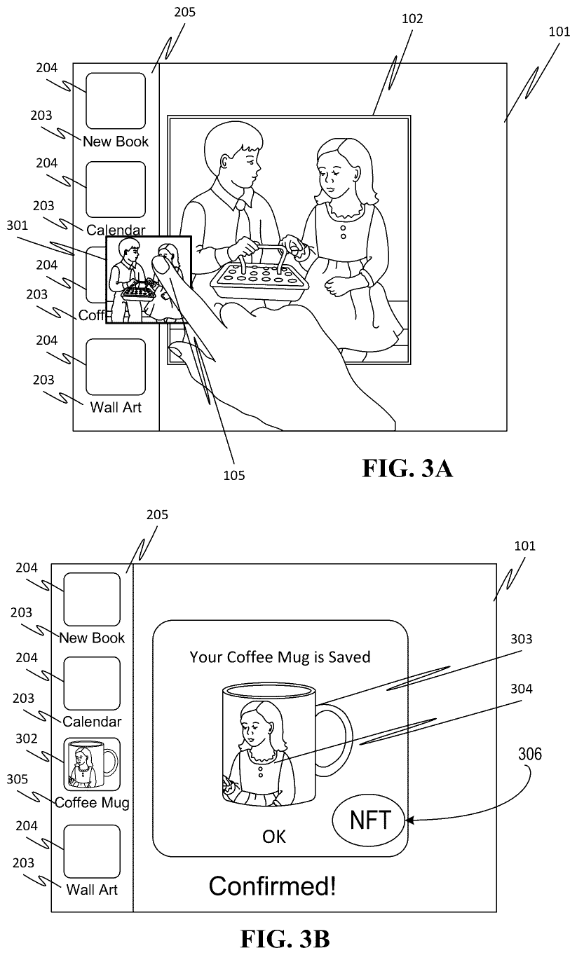

Referring now to FIG. 3A, the user can select the particular desired article of Merchandise by dragging and dropping the chosen image 102 using a user input device, such as a computer mouse or the user's finger 105, to the picture frame-shaped box 204 corresponding to the user's chosen article of Merchandise. FIG. 3A demonstrates the user creating a coffee mug from image 102. In some embodiments, as the user moves the selected image 102, it is automatically resized to fit the picture frame-shaped box 204. The resized image of the picture may be displayed on the article of merchandise such that the user may view a representation of an item to be generated with the image of the picture 301.

Referring now to FIG. 3B, in some embodiments, following the user selection of a particular desired article of Merchandise, the image display application 101 displays at least one preview 304 of the desired article of Merchandise, 305, as it would appear with the chosen image 302, 304. By way of non-limiting example, a preview 304 of a customized coffee mug may comprise the chosen image 102 wrapped around the generally cylindrical body of the coffee mug 303. In some embodiments, the image display application presents users with additional options for finalizing the Merchandise, such as, by way on non-limiting example, cropping the image, rotating the image, resizing the image or applying an annotation to the image. A virtual article of merchandise 303 corresponds with the physical article of merchandise 305. One or more of an NFT 306 is associated with the physical article of merchandise 305 and an NFT is associated with the virtual article of merchandise 304.

In some embodiments, a set of Cartesian Coordinates may be associated with one or more segregated spatial areas on a Merchandise item. The segregated spatial areas may designate a position for a selected image to reside on a Merchandise item. The invention includes the provision of a user interface that allows a user to select an image, such as for example via a designation of an X,Y coordinate or other set of coordinates (e.g. Cartesian Coordinate or Polar Coordinate), and to additionally select a merchandise item via the use of coordinates, such as Cartesian or Polar coordinates designating a position within the user interface associated with the Merchandise item. Finally, a third set of coordinates, such as Cartesian Coordinates or Polar Coordinates, may be used to designate a position to generate a copy of the selected upon the Merchandise item.

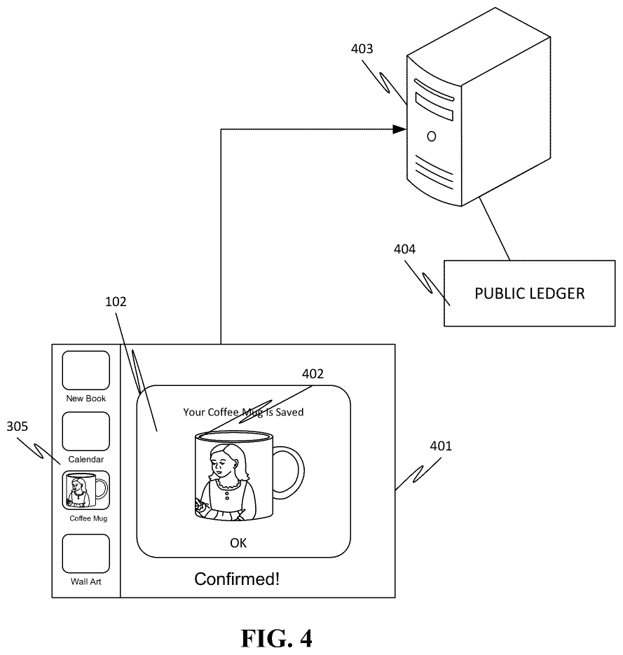

Referring now to FIG. 4, the user's Device 401 transmits through its network access device by wireless network, LTE cellular data connection, internet protocol, or other data transfer protocol, the user's order 402 to a remote server 403, for processing and creation of the actual Merchandise. The user's order comprises one or more images 102 and a chosen article of Merchandise 305, and may in some embodiments also comprise any alterations to the one or more images 102 provided by the user. In some embodiments, the photo may be exported to Merchandise site with the ability to include image 102 in an article of Merchandise. In some embodiments, image 102 may be transmitted to a photographer. In some embodiments, a photographer may capture image 102 and receive a royalty from any article of Merchandise sold based on image 102. In some embodiments, use fees may be applicable for reproduction. Device 401 may be in logical connection with an appropriate digital rights management apparatus to give or receive appropriate rights permissions in image 102.

In some embodiments, the user will have access only to images 102 for which the user has permission to generate Merchandise. In other embodiments, the user will have access to a larger set of images, and the user's permission to use a given image in generating Merchandise will be checked after the user has selected the image. For a collection of images, such as a memory book or yearbook, a user may receive a third-party authorization (such as from an event organizer or a school representative). The third-party authorization is additionally transmitted to a manufacturer thereby authorizing the generation of the customized article of merchandise.

A public ledger may be maintained by the server and securely store details of the transactions and processes described herein. The public ledger will preferably be a block-based record-keeping system that maintains transaction details and other details, such as participants' identities. The identities may be stored in semi-anonymous form, respective NFT assets 306 (such as physical and/or virtual articles of merchandise), and a record book of all the transactions executed between network participants.

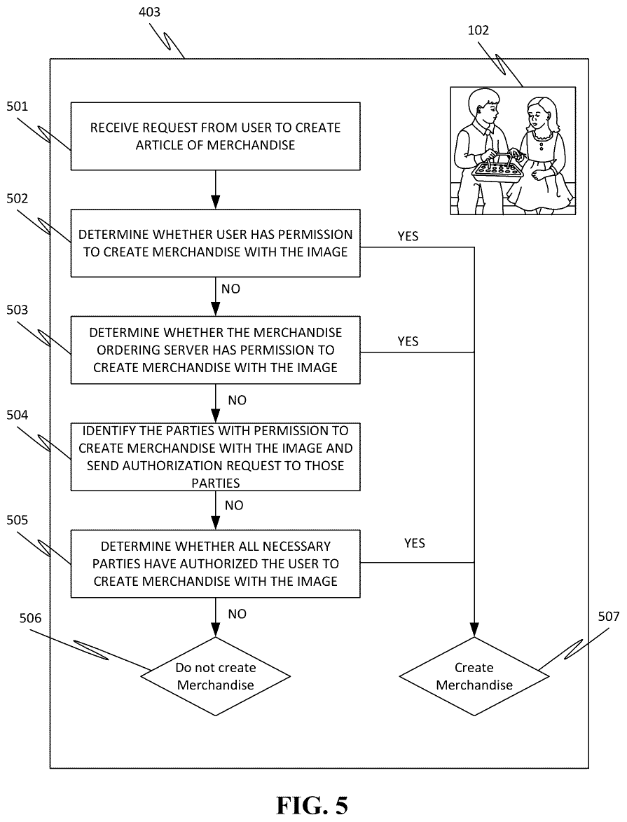

Accordingly, referring now to FIG. 5, there may be numerous methods relating to the verification of permission to use certain images. These methods may share some or all of a select set of common steps. In FIG. 5, these common steps may be depicted. The server 403 will receive 501 the desired at least one image 102.

The server 403 can then determine 502 whether the user has permission to create Merchandise with the at least one image 102. There may be many methods for verifying that the user has permission to create Merchandise with the at least one image 102. These methods may include metadata verification that the image is a picture taken with a camera corresponding to the user's Device; use of facial recognition software to match the subject of the at least one image 102 with on-file photographs of the user; or an affirmation by the user that he has the right to generate Merchandise with the at least one image 102. If it is verified that the user has permission to create Merchandise with the at least one image 102, then the order will be processed 507.

If the server cannot determine 502 that the user has permission to create Merchandise with the at least one image 102, then the server may verify 503 that the owner of the server has permission to create Merchandise with the at least one image 102. For example, image hosting service Instagram requires that its users grant Instagram a royalty-free license to use in connection with advertising any content the users upload to Instagram. See Terms of Use, INSTAGRAM, http://help.instagram.com/478745558852511 (last updated Jan. 19, 2013). If the server owner has a similar license with respect to the at least one image 102, then the order will be processed 507.

If neither the user nor the server owner has permission to create Merchandise with the at least one image 102, then the server will 504 identify the other party whose permission is needed to use the at least one image 102. The other party may be at least one of: the photographer of the at least one image 102, a person depicted in the at least one image 102, or the parent of the person depicted in the at least image 102 if the person is a minor. There may be numerous methods to identify the other party whose permission is needed, including, but not limited to, facial recognition software or use of user- or computer-inputted metatags on the at least one image 102 itself.

The server will then seek authorization 505 from the other party to create Merchandise with the at least one image 102. There may be numerous methods to seek authorization from the other party, including, but not limited to, automatically generating an email, or if the other party also has the image display application 101 on a Device owned by her, transmitting a signal to the image display application 101 on the other party's Device that prompts the other party to give or decline authorization. If the other party grants authorization to create Merchandise with the at least one image 102, then the order will be processed 507. If the other party does not grant authorization, then the order will be deleted 506, and the server 403 will transmit a cancellation message to the user's Device. Server 403 may also be operative to assemble a photobook based on the at least one image 102 to send to third parties. The third parties may also create their own Merchandise based on the at least one image 102. In some embodiments, the third parties may receive compensation for sales for such Merchandise.

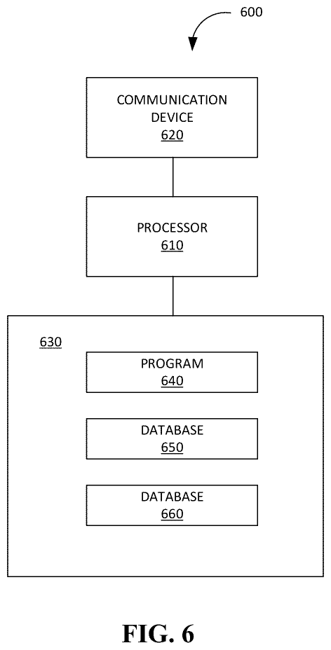

In addition, FIG. 6 illustrates a controller 600 that may be utilized to implement some embodiments of the present invention. The controller may be included in one or more of the apparatus described above, such as the Revolver Server, and the Network Access Device. The controller 600 comprises a processor unit 610, such as one or more semiconductor-based processors, coupled to a communication device 620 configured to communicate via a communication network (not shown in FIG. 6). The communication device 620 may be used to communicate, for example, with one or more online devices, such as a personal computer, laptop, or a handheld device.

The processor unit 610 is also in communication with a storage device 630. The storage device 630 may comprise any appropriate information storage device, including combinations of storage devices (e.g., cloud storage, mechanical disk drives, solid state disk drives), and/or semiconductor memory devices such as Random Access Memory (RAM) devices and Read Only Memory (ROM) devices.

The storage device 630 can store a software program 640 for controlling the processor unit 610. The processor unit 610 performs instructions of the software program 640, and thereby operates in accordance with the present invention. The processor unit 610 may also cause the communication device 620 to transmit information, including, in some instances, control commands to operate apparatus to implement the processes described above. The storage device 630 can additionally store related data in a database 650 and database 660, as needed. The data may include GPS, timestamp, resolution, general EXIF metadata, IPTC metadata, etc.

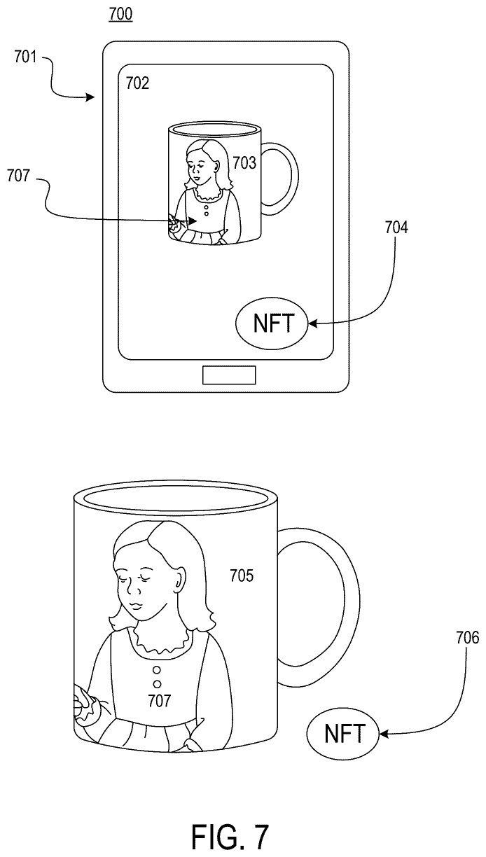

Referring now to FIG. 7, a schematic diagram 700 illustrates a physical article of merchandise 705 (as illustrated a mug) with a designated photo 707 and an associated NFT 706. The associated NFT may convey rights in one or both of the photo 707 and the physical article of merchandise 705.

A corresponding virtual article of merchandise 703 may be created in a virtual world and displayed on a user interface 702 on a computing device 701. A second NFT 704 may be associated with the virtual article of merchandise 703.

According to the present invention, a physical article of merchandise 705 may be created with input from a user specifying one or more photos (such as a first photo and a second photo) and a physical placement of the one or more photos on the physical article 705. A virtual article of merchandise 703 corresponds with the physical article of merchandise 705. One or more of an NFT 706 is associated with the physical article of merchandise 705 and an NFT associated with the virtual article of merchandise 704.

A public ledger 404 may be maintained on one or more servers that records transfers of ownership and other details related to one or more of the physical article of merchandise 705, the virtual article of merchandise 703, and the photo 707.

The public ledger may include a record-keeping system (apparatus with executable software software) that is operable to maintain participants' identities in secure and (pseudo-)anonymous form, their respective NFT assets, and a record book of all the genuine transactions executed between network participants.

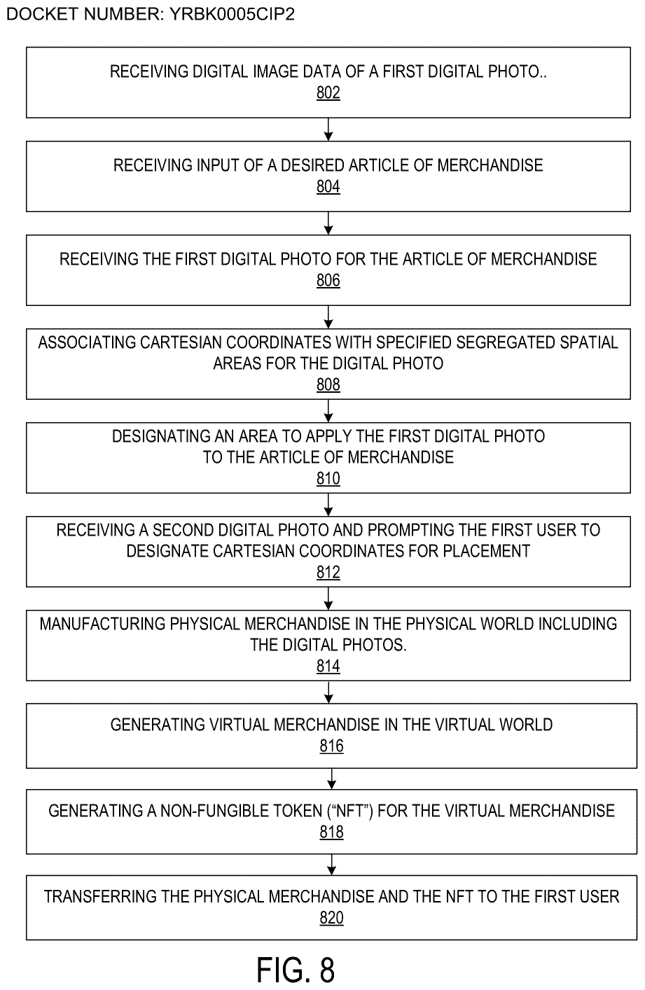

Referring now to FIG. 8, a flowchart illustrates a method for generating a physical article of merchandise in the virtual world, and a virtual article of merchandise in a virtual world, according to some embodiments of the present disclosure. At step 802, the method may include receiving digital image data from an image capture device, the digital image data representative of a first digital photo. At step 804, the method may include receiving from a first user an input choosing a desired article of merchandise. At step 806, the method may include receiving the first digital photo to be applied to the article of merchandise. At step 808, the method may include associating Cartesian Coordinates with one or more specified spatial areas of the first digital photo received from the image capture device.

At step 810, the method may include designating an area to apply the first digital photo to the article of merchandise. At step 812, the method may include receiving a second digital photo and prompting the first user to designate desired Cartesian Coordinates on the article of merchandise. In some embodiments, to apply the first digital photo and the second digital photo. At step 814, the method may include manufacturing the article of merchandise in the physical world (“physical merchandise”), the physical merchandise comprising a replication of the first digital photo and the second digital photo.

At step 816, the method may include generating a virtual article of merchandise in a virtual world (“virtual merchandise”), the virtual merchandise comprising a virtual replication of the first digital photo and the second digital photo. At step 818, the method may also include generating a non-fungible token (“NFT”) for the virtual merchandise. At 820, the method may include transferring one or both of the physical merchandise to the first user and transferring ownership of the NFT to the first user.

In some embodiments, the method may additionally include the step of recording a transfer of one or both of: the article of merchandise in the physical world, and the NFT in a public ledger. In some preferred embodiments, the public ledger may be a blockchain ledger.

According to some embodiments, a public ledger that records ownership of one or both of: the physical merchandise, and an associated NFT may include data management and storage system such as, for example, a cloud-based database system. Preferred embodiments include a blockchain based public ledger, which may include a series (or chain) of blocks on which transaction details are recorded after suitable authentication and verification by network participants.

A recording and storage of confirmed transactions on such public ledgers at the start of a related series of transactions, such as all photos in a particular collection (e.g., all photos of students from a particular school). If a block is pending a state of capacity with transaction details, one or more new blocks may be mined and added to the blockchain by a designated network participant (e.g., a miner). Some network participants may receive and store a full copy of an entire ledger on a specified device that is connected to an associated trading network. The public ledger may be distributed in a manner conducive to participants connecting and contributing to blockchain network activities in order for it to maintain its functionality.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings and the detailed description thereto are not intended to limit the present disclosure to the form disclosed, but to the contrary, the present disclosure is to cover all modification, equivalents and alternatives falling within the spirit and scope of embodiments of the present disclosure as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising,” “including,” and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

In certain implementations, multitasking and parallel processing may be advantageous. Nevertheless, it will be understood that various modifications may be made without departing from the spirit and scope of the claimed disclosure.

What is claimed is:

1. An apparatus for generating articles of merchandise with selected images, comprising:
a communication interface configured to receive a request from a user to create an article of merchandise with a selected image;
a processor configured to determine whether the user has permission to create the article of merchandise with the selected image;
an authorization system configured to verify permissions from necessary parties if the user does not have direct permission; and
a merchandise creation system configured to create the article of merchandise with the selected image, if all necessary permissions are obtained.

2. The apparatus of claim 1, wherein the communication interface is further configured to send authorization requests to parties with permission to create the article of merchandise with the selected image.

3. The apparatus of claim 1, wherein the processor is further configured to identify parties with permission to create the article of merchandise with the selected image.

4. The apparatus of claim 1, wherein the authorization system is further configured to determine whether all necessary parties have authorized the user to create the article of merchandise with the selected image.

5. The apparatus of claim 1, wherein the merchandise creation system is further configured to not create the article of merchandise if all necessary parties have not authorized the user.

6. The apparatus of claim 1, further comprising a user interface configured to display a status of permission requests to the user.

7. The apparatus of claim 1, wherein the communication interface is configured to receive image data from the user.

8. The apparatus of claim 1, wherein the processor is configured to store user permission data in a database.

9. The apparatus of claim 1, further comprising a database configured to store information about parties with permission to create the article of merchandise with specific images.

10. The apparatus of claim 1, wherein the authorization system is configured to log all authorization requests and responses.

11. The apparatus of claim 1, wherein the merchandise creation system is configured to generate a preview of the article of merchandise with the selected image.

12. The apparatus of claim 1, further comprising a notification system configured to inform the user of a completion of a merchandise creation process.

13. The apparatus of claim 1, wherein the processor is configured to handle multiple merchandise creation requests simultaneously.

14. The apparatus of claim 1, wherein the communication interface is configured to operate over a network to facilitate remote user requests.

15. The apparatus of claim 1, wherein the authorization system is configured to handle permissions for multiple types of merchandise items.

16. The apparatus of claim 1, wherein the merchandise creation system is configured to apply image processing techniques to enhance the selected image before creating the article of merchandise.

17. The apparatus of claim 1, further comprising a security system configured to ensure that all communications and data storage are secure.

18. The apparatus of claim 1, wherein the processor is configured to generate reports on merchandise creation activities.

19. The apparatus of claim 1, wherein the communication interface is configured to support multiple communication protocols.

20. The apparatus of claim 1, wherein the merchandise creation system is configured to support various merchandise formats, including clothing, accessories, and home decor items.
